(19) United States
(12) Patent Application Publication
(10) Pub. No.: US 2005/0147824 A1
(43) Pub. Date: Jul. 7, 2005

(54) Surface initiated graft polymerization

(75) Inventor: David L. Myers, Cumming, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/748,893

(22) Filed: Dec. 30, 2003

(51) Int. Cl. B05D 3/00; B32B 27/16

(52) U.S. Cl. 428/411.1; 427/532

(57) ABSTRACT

Disclosed herein is a method for modifying a surface of a polymeric substrate, comprising providing a substrate, exposing at least one surface of the substrate to energy to form surface radical forming groups on the surface, treating the substrate with a fluid comprising at least one type of monomer and subjecting the treated substrate to activation energy to cleave at least some of the radical forming groups and initiate graft polymerization of the monomer. The graft polymerization initiated thereby does not require added photoinitiator.

### BACKGROUND OF THE INVENTION

Many of the medical care garments and products, protective wear garments, mortuary and veterinary products, and personal care products in use today are partially or wholly constructed of polymeric sheet materials including extruded filamentary or fibrous web materials such as nonwoven web materials, extruded polymeric film materials and extruded polymeric foam materials. Examples of such products include, but are not limited to, medical and health care products such as defibrillator pads, monitoring electrode pads, surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. Other uses for nonwoven web materials and polymeric film materials include geotextiles and house wrap materials. For these applications the sheet materials provide functional, tactile, comfort and/or aesthetic properties.

The surface properties of polymeric sheet materials may be altered to produce desired characteristics. As an example, the polymeric films and foams and fibers of nonwoven webs are often made of or include one or more thermoplastic polymers which are strongly hydrophobic, but for many of the applications in which polymeric sheet materials are to be used it is highly desirable for the material to be hydrophilic, that is, to have a certain affinity for water. It is known to treat or coat the surfaces of polymeric sheet materials topically with surface active agents such as, for example, cationic surfactants, and thus make the material wettable. However, these treatment preparations are often fugitive and prone to washing off of the polymeric sheet material after one or more instances of wetting. It is also known to coat a hydrophobic polymeric surface with a photochemically polymerizable monomer in the presence of photoinitiating chemicals and then polymerize the monomer as a more hydrophilic polymer coating on the hydrophobic polymeric sheet material. However, this may be undesirable for skin-contacting uses of the polymeric sheet material due to the presence of residual amounts of the potentially hazardous photoinitiating chemicals and byproducts thereof. Furthermore, such surface coatings of photochemically polymerized hydrophilic polymer also suffer from the same drawbacks as topical treatment or coating in that they are capable of being washed off. Thus, there is a continuing need for efficient and durable methods for surface modification of polymeric sheet materials.

### SUMMARY OF THE INVENTION

The invention provides a method for modifying a surface of a polymeric substrate. The method includes the steps of providing a polymeric substrate, exposing at least one surface of the polymeric substrate to energy to form surface radical forming groups on at least one surface of the polymeric substrate, treating the polymer substrate with a fluid comprising at least one type of monomer and subjecting the treated polymeric substrate to activation energy to cleave at least some of the radical forming groups and initiate graft polymerization reaction of the monomer, and where the step of subjecting the treated substrate to activation energy is performed substantially in the absence of added photoinitiator.

In embodiments, the polymeric substrate may desirably comprise one or more polymers such as polyolefins or polyesters. Desirable polyolefins may include polypropylene and polyethylene. The fluid comprising monomer may desirably be an aqueous solution including a monomer. The fluid comprising monomer may desirably include one or more ethylenically unsaturated monomers. The monomer may desirably include such as acrylic acid or methacrylic acid. The polymeric substrate may desirably be a sheet material including such as nonwoven web materials, film materials, foam materials, and/or laminates of webs, films and/or foams. The energy to form surface radical forming groups may be supplied by such as a corona discharge. The activation energy may desirably be ultraviolet radiation. The polymeric substrate may desirably be subjected to activation energy under conditions of reduced oxygen presence. The fluid comprising monomer may desirably further comprise one or more crosslinking agents. It may be further desirably to treat the surface modified polymeric substrate with a weak Lewis base or a strong Lewis base to form the conjugate base/conjugate acid salt. Also provided herein are surface modified polymeric substrates produced in accordance with the embodiments of the method of the invention.

### Definitions

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries. As used herein the term “thermoplastic” or “thermoplastic polymer” refers to polymers that will soften and flow or melt when heat and/or pressure are applied, the changes being reversible.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” filament refers to a filament or fiber formed from one or more extruders using only one polymer extrudate. This is not meant to exclude filaments formed from one polymer to which small amounts of additives have been added for color, anti-static properties, lubrication, hydrophilicity, etc.

As used herein the term “multicomponent fibers” refers to fibers that have been formed from at least two component polymers, or the same polymer with different properties or additives, extruded from separate extruders but spun together to form one filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the term “biconstituent fiber” or “multiconstituent fiber” refers to a fiber or filament formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils that start and end at random.

As used herein the term “nonwoven web” or “nonwoven fabric” means a web having a structure of individual fibers or fibers that are interlaid, but not in an identifiable manner as in a knitted or woven fabric. Nonwoven fabrics or webs have been formed from many processes such as for example, meltblowing processes, spunbonding processes, airlaying processes, and carded web processes. The basis weight of nonwoven fabrics is usually expressed in grams per square meter (gsm) or ounces of material per square yard (osy) and the fiber diameters useful are usually expressed in microns. (Note that to convert from osy to gsm, multiply osy by 33.91).

The term “spunbond” or “spunbond nonwoven web” refers to a nonwoven fiber or filament material of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,692,618 to Dorschner et al., and U.S. Pat. No. 3,802,817 to Matsuki et al. Typically, spunbond fibers or filaments have a weight-per-unit-length in excess of about 1 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers or microfibers formed by extruding a molten thermoplastic material through a plurality of fine, usually circular, die capillaries as molten threads or filaments or fibers into converging high velocity, often heated gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are often smaller than 10 microns in average diameter and are frequently smaller than 7 or even 5 microns in average diameter, and are generally tacky when deposited onto a collecting surface.

As used herein, the term “hydrophilic” with regard to polymeric or cellulosic material means that the material has a surface free energy such that the material is wettable by an aqueous medium, i.e. a liquid medium of which water is a major component. The hydrophilicity of materials can be measured, for example, in accordance with the ASTM-D-724-89 contact angle testing procedure. For example, a hydrophilic polymeric material has an initial contact angle with water equal to or less than about 90 degrees. Depending on material application needs and degree of hydrophilicity desired, this term includes materials where the initial contact angle may desirably be equal to or less than about 75 degrees, or even equal to or less than about 50 degrees. The term “initial contact angle” as used herein indicates a contact angle measurement made within about 5 seconds of the application of water drops on a test film specimen. The term “hydrophobic” includes those materials that are not hydrophilic as defined. It will be recognized that hydrophobic materials may be treated internally or externally with surfactants and the like to render them hydrophilic, and that slightly or moderately hydrophilic materials may be treated to make them more hydrophilic.

### DETAILED DESCRIPTION OF THE INVENTION

The present invention provides a method for modifying a surface of a polymeric substrate. The method may be beneficially used, for example, for surface modification of fibrous fabrics and materials such as in nonwoven webs and other polymeric sheet materials such as for example film materials and foam materials, and/or for composites or laminates comprising two or more of the foregoing. The invention will be described with reference to certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extends to all such variations and equivalents.

The method for modifying the surface of the polymeric substrate includes the steps of forming surface radical forming groups on the surface of the polymeric substrate, treating the polymer substrate with a fluid comprising at least one monomer, and then subjecting the treated substrate to activation energy to graft polymerize the monomer onto the treated polymeric substrate. A radical forming group, for example, is capable of forming radicals on the surface of the polymeric substrate upon exposure of the polymeric substrate to activation energy. More particularly, a radical forming group is capable of forming free radical species upon exposure to heat energy or light of appropriate wavelength by causing homolytic cleavage of a sigma bond, yielding two radical species with a single unpaired electron each. Examples of radical forming groups include peroxides and hydroperoxides, and species having isolated carbonyl groups such as ketonic and aldehydic groups. The surface radicals formed therefrom upon cleavage act as polymerization initiating sites for polymerization of the monomer. Surface radical forming groups may be formed on the surfaces of polymeric substrates by exposing the polymeric substrate to ionizing radiation by methods as are known in the art, such as for example corona discharge treatment, plasma treatment or other ionizing energy. An exemplary method for corona discharge treatment is disclosed in co-assigned U.S. Pat. No. 5,688,465 to Myers, the entire disclosure of which is incorporated herein by reference, wherein a polymeric sheet material to be treated by corona discharge is protected from the excessive damage which may otherwise be caused by localized arcing to ground.

The treatment fluid comprising at least one monomer may be a solution comprising one or more monomers dissolved in a solvent. As an example, the fluid may comprise one or more monomers dissolved in water or other solvent. As another example, where the monomer itself is a liquid at the ambient treatment temperature, the polymeric substrate may be treated with the liquid monomer. Desirably, the monomer is an ethylenically unsaturated monomer such as, for example, ethylenically unsaturated carboxylic acid monomers. Suitable monomers include acrylic acid and alpha substituted acrylic acid monomers such as methacrylic acid, ethylacrylic acid, dimethacrylic acid and others such that the alkyl substituent(s) alpha to the carbonyl of the carboxylic acid group do not render the monomer immiscible in water (e.g., —CnH2n+1, where n<6). Other useful monomers include acrylamide and alpha substituted acrylamide monomers such as methacrylamide. Still other useful monomers include N-alkyl substituted acrylamides and methacrylamides such as N-ethyl acrylamide or N-ethyl methacrylamide, and N,N-dialkyl substituted acrylamides and methacrylamides such as N,N-diethyl acrylamide or N,N-diethyl methacrylamide. Still other monomers may be used, such as, for example, glycerol monoacrylate, monoacryloxyethyl phosphate, citraconic anhydride, vinyl methyl sulfone, N-vinyl-2-pyrrolidone, and 1-vinyl imidazole.

After the polymeric substrate has been treated with the desired monomer, the monomer is graft polymerized by subjecting the treated polymeric substrate to exposure with a source of activation energy. The activation energy initiates a linear graft polymerization reaction of the monomer by cleaving at least some of the radical forming groups to form free radicals on the surface of the polymeric substrate, and the free radicals initiate graft polymerization of the monomer starting at the surface radical sites (or radical forming group sites) which were formed by exposure to ionizing radiation. It may be desirable, however, to remove excess monomer from the polymeric substrate prior to initiating graft polymerization. This may be done by the simple expedient of passing the treated polymeric substrate through a nip formed between rollers, such as rubber or rubber coated rollers, to squeeze off the excess treatment fluid, and/or vacuum suction, and/or by blotting the treated polymeric substrate with absorbent media such as paper or cloth towels or the like. The activation energy may be provided by methods as are known in the art, such as for example by exposure to ultraviolet radiation or electron beam radiation. Desirably, the activation energy is provided by exposure to ultraviolet radiation (UV) such as may be provided by excimer lamp or other UV emitting lamp.

It should be noted that because the surface radicals formed from the radical forming groups on the surface of the polymeric substrate act as the graft polymerization initiating sites, it is not necessary to add any chemical photoinitiator to the treatment monomer fluid, nor is it necessary to pre-treat the polymeric substrate with any added chemical photoinitiators. Indeed, for a number of reasons it is undesirable to add any chemical photoinitiator. Chemicals utilized as photoinitiators, such as aryl alkyl ketones such as acetaphenone and various substituted acetaphenones, aryl ketones such as benzophenone and various substituted benzophenones, dibenzoyl peroxide and various diaryl peroxides, dialkyl peroxides, and aryl alkyl peroxides, as well as azo and bis-azo compounds such as azoisobutyronitrile and azobiscyanovaleric acid are well known in the art and readily commercially available. However, where the ultimate use for the polymeric sheet material includes contact with human skin it is desirable to minimize the presence of residual chemicals such as photoinitiators. Also, because the graft polymerization initiation site is present at the surface of the polymeric substrate rather than intermixed in the monomer treatment fluid (as is the case where a photoinitiator is used), superior adhesion of the graft polymer to the polymeric substrate is provided. Additionally, again because the graft polymerization initiation site is localized to the surface of the polymeric substrate, graft polymerization proceeds preferentially, and little homopolymerization of the monomer occurs.

Desirably, the treated polymeric substrate will be subjected to the activation energy in a reduced oxygen or non-oxidative environment, such as by placing the polymeric substrate in a reaction vessel or passing the polymeric substrate through a reaction chamber from which the air has been purged prior to energy activation of the monomer. The air may be purged from such a reaction vessel or chamber by purging with inert gas such as argon or nitrogen. This is desirable because atmospheric oxygen can act as a reaction terminator by combining with the surface radical sites formed from the radical forming groups on the surface of the polymeric substrate, and thereby reduce the number of graft polymerization initialization sites available to the monomer.

As mentioned above, after the polymeric substrate has been treated with a monomer-containing fluid it is often desirable to remove the excess treatment fluid by squeezing and/or blotting, and this is particularly desirable when it is desired to form a thin coating of graft polymer on the surface of a nonwoven web or film or foam material. However, it may also be highly desirable for certain applications that one or both surfaces of a polymeric substrate such as a polymeric film material be grafted with a hydrophilic polymer in a thicker coating of hydrophilic polymer such that the grafted coating may serve as a coating of hydrogel. Such hydrogel coated polymeric films are useful for many medical applications including but not limited to such as defibrillator pads, cardiac monitoring electrode pads, transdermal drug delivery patches, and the like. Where a thicker coating of the grafted polymer is desired it may be desirable to avoid removing excess treatment fluid. In addition, it may be desirable to add a crosslinking agent or crosslinking monomer such as triallyl phosphate, trivinyl cyclohexane, bis (2-methacryloxyethyl) phosphate, 1,4-butanediol diacrylate, 1,4-butanediol dimethacrylate, diethylene glycol diacrylate, diethylene glycol dimethacrylate, glycerol trimethacrylate, triallyl cyanurate, triethylene glycol diacrylate, or others such as known in the art in order to produce a cross-linked and/or branched graft polymer.

Depending on the desired end use for the grafted polymeric substrate material, it may be desirable to convert the acidic polymer to its conjugate base form. While both the acid form of the polymer and the conjugate base form of the grafted polymer are hydrophilic and allow the grafted polymeric substrate material to be wetted with aqueous liquids, the conjugate base form is preferred for end uses where liquid absorbency is desired. The graft polymer may be converted to its conjugate base form by methods known in the art such as a neutralization reaction with a molar excess of a strong Lewis base such as sodium hydroxide or potassium hydroxide to yield the conjugate base/conjugate acid salt. For example, sodium acrylate or potassium acrylate would result from the neutralization of an acrylic acid grafted polymer using the two Lewis bases disclosed above. Where desired, partial neutralization might be accomplished by titrating the acid groups with the Lewis base such that less that 100 percent conversion to the salt form is achieved. This would provide a substrate capable of further reactions with either acidic or basic species, such as might be desired in a commercial/industrial sorbent pad. In addition, the acid form of the grafted polymer could be reacted with a weak Lewis base, such as an organic amine, which might be desirable in forming a controlled release drug delivery device.

Although the embodiments of the invention are herein described with respect to various types of melt-extruded thermoplastic fibers, films and foams, it is believed the invention is not limited thereto and may also be beneficially used with other types of polymeric surfaces such as for example those produced by flash spun fiber production processes and solution spun fiber production processes. However, without desiring to be limited, it is believed that the invention is particularly well suited for use with polymeric sheet materials as may be produced by melt-extrusion of thermoplastic polymers. Polymers generally suitable for extrusion of fibers and/or films and/or foams from a thermoplastic melt include the known polymers suitable for production of nonwoven webs and film materials such as for example polyolefins, polyesters, polyamides, polycarbonates and copolymers and blends thereof. It should be noted that the polymer or polymers may desirably contain other additives such as processing aids or treatment compositions to impart desired properties, residual amounts of solvents, pigments or colorants and the like.

Polyolefins known to be suitable generally for melt-extrusion of fibers, films and/or foams include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof.

In addition, many elastomeric polymers are known to be suitable for forming fibers or films. Elastic polymers useful in making extruded fibers and films may be any suitable elastomeric resin including, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from the Kraton Polymers of Houston, Tex. under the trade designation KRATON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from Exxon of Houston, Tex., as well as blends.

Polymers believed to be particularly well suited for use in the invention include, generally, any polymer having a surface susceptible to peroxidation by ionizing energy such as plasma or corona discharge treatment, thereby leading to the formation of surface peroxides, hydroperoxides or isolated carbonyl groups. More particularly, the polyolefin and polyester polymers listed above are well suited.

### EXAMPLES

Corona Discharge Treatment. The corona discharge was generated using a Corotec Laboratory Corona Treating Station (Corotec Corporation, Collinsville, Conn.) equipped with a CXC-5 power supply. The Corotec Laboratory Corona Treating Station generates a high voltage AC corona discharge. The voltage of the discharge (peak to peak) ranges from 7 kiloVolt (kV) to 10 kV and the frequency ranges from 19 kiloHertz (kHz) to 20 kHz. The treating station utilizes two horizontally positioned, counter-rotating aluminum rolls as the electrodes. The bottom roll is grounded and its surface is covered by a 2 millimeter (mm) thick dielectric sleeve. The top roll is bare aluminum metal. The nip point formed by the two rolls provides a minimum gap of 2 mm. The actual gap between the electrodes during the treatment of a material is the sum of the thickness of the material being treated in the gap and the 2 mm thick dielectric sleeve on the lower electrode. The line speed was 12 feet per minute (about 3.66 meters per minute). The power dissipated in the gap during corona discharge is indicated by an integral power meter.

The corona energy density is a quantitative measure of power dissipated across the width of the electrodes per unit area of material being treated. This is simply expressed by dividing the output power of the power supply by the width of the anode (e.g., feet) and the line speed (e.g., feet/second). Energy density is assumed to be a cumulative function of the number of passes through the discharge. Typically, materials were passed through the discharge from 1 to 10 times. Table 1 lists energy density per pass for typical output power used in this work.

TABLE 1
Corona Energy Density

| Output Power^{a} | Energy Density^{b} |
|---|---|
| 100 | 500 (5.38) |
| 200 | 1000 (10.8) |
| 300 | 1500 (16.2) |
| 400 | 2000 (21.5) |
| 500 | 2500 (26.9) |

^{a}In Watts or Joules per second
^{b}In Watt-seconds per square foot (kiloJoule per square meter)

Substrate materials were corona treated substantially according to the teachings of U.S. Pat. No. 5,688,465 to Myers and as herein described. Typically, samples of polypropylene spunbond-nonwoven media were corona treated at a corona output power of 300 Wafts and five passes through the active corona yielding a total energy input of 7,500 Watt-seconds per square foot (81.0 kJ per square meter).

Ultraviolet Reactor. Photochemical reactions were carried out in an annular ultraviolet light reactor (Rayonet Photochemical Reactor, The Southern New England Ultraviolet Company, Branford, Conn.) equipped with 16 low pressure mercury lamps. Each lamp had a principle emission wavelength of 254 nanometers (nm). The combined output of all 16 lamps, measured at the center of the reaction chamber, was 6 milliWatts per square centimeter. In a typical experiment, nonwoven samples were irradiated for 10 minutes inside a tubular reactor constructed of fused quartz glass, which had been sealed and purged with an inert gas such as nitrogen (N₂) or argon (Ar) gas in an effort to exclude as much free oxygen (O₂) from the reaction vessel as possible.

Acrylate Monomer Solution. Acrylate monomer solutions were prepared using chemically pure acrylate monomers supplied by Aldrich Chemical Company (Milwaukee, Wis.). Aqueous solutions were prepared using 18 MΩ (mega ohm) deionized water, which had also been de-oxygenated by sparging with nitrogen gas for 30 minutes. Acrylic acid monomer was purified by vacuum distillation and was stored under nitrogen after purification.

Characterization. Fourier transform infrared (FT-IR) spectra were collected using a Nicolet Model 205 Fourier transform Infrared Spectrometer available from Thermo Nicolet (Madison, Wis.). Typically, spectra were collected with a Harrick vertical attenuated total reflectance accessory using a 45 degree KRS-5 crystal.

### Example 1

Samples of a monocomponent polypropylene spunbonded nonwoven web having a basis weight of about 1.5 ounces per square yard (about 51 grams per square meter) and having an average fiber size of about 1 denier obtained from the Kimberly-Clark Corporation, Irving, Tex., were corona treated substantially according to the teachings of U.S. Pat. No. 5,688,465 and as mentioned above in order to cause surface peroxidation of the fibers. A sample of this corona treated nonwoven web was then immersed in an aqueous solution of 30 weight percent acrylic acid monomer which had been prepared as described above for a period of 60 seconds to allow the monomer solution to fully impregnate the fibrous structure of the nonwoven. The monomer-impregnated nonwoven web was then placed between two sheets of polyester film and passed through a nipped roller assembly to remove excess monomer solution. The nipped fabric appeared dry to visual inspection; however, on contact with a dry cellulosic blotter moisture was wicked away from the polypropylene nonwoven. This was taken to indicate that although the nonwoven was saturated with monomer solution, a large excess of the solution was not present. The monomer solution appeared to have completely filled the interstitial spaces within the fibrous structure. The saturated polypropylene nonwoven web was placed in a tubular quartz reactor, which was capped and purged with inert gas for at least 30 minutes at 1 atmosphere total pressure.

On completion of the inert gas purging, the quartz reactor was suspended in the center of the annular UV reactor and the irradiated for 10 minutes in order to initiate graft polymerization of the acrylate monomer. Following irradiation, the tubular reactor was again purged with nitrogen or argon to remove any potentially hazardous gas phase species that may have been generated during irradiation. (Typically, the gas phase species when purged through water, yielded a solution with a pH of less than about 4, which suggested that a small amount of acrylic acid monomer was liberated during the irradiation, most probably due to heating of the sample during the reaction.) Upon removal from the reactor the polypropylene nonwoven web was white in color and had become noticeably rigid.

The polyacrylic acid grafted polypropylene nonwoven web was washed three times in deionized water to ensure that any residual monomer was removed. The pH of the final rinseate was equivalent to that of the deionized water (5.5). After washing, the grafted nonwoven web was dried at 100 degrees C. for 1 hour.

The dried grafted nonwoven web was very rigid and did not display any of the normal drape characteristics associated with nonwoven web materials. Samples of the grafted material were readily dyed by Saffranine O (a cationic azine dye) yielding a deep crimson red fabric having a high degree of color uniformity. In addition, the samples of the grafted material were dyed with Malachite green oxalate (a cationic triphenylcarbinol dye) yielding a deep green fabric having a high degree of color uniformity. Hydrophobic materials such as polyolefinic nonwoven web or film materials will not normally take up these types of dyes. The color intensity and uniformity of the dyed grafted materials was unaffected by repeated washing in water or in a 50 percent aqueous solution of 2propanol, indicating that the hydrophilic polyacrylic acid was permanently grafted onto the otherwise hydrophobic nonwoven web material.

Samples of the acrylic acid grafted nonwoven web were examined using attenuated total reflectance Fourier transform infrared spectroscopy (ATR-FT-IR). The reflectance infrared spectra were consistent with a carboxylic acid. Strong absorbances at 1700 cm⁻¹, 1370 cm⁻¹, and 1160 cm⁻¹ were observed corresponding to the carbonyl C═O stretching, O—H in-plane deformation, and carboxylic acid C-0 stretching vibrational modes, respectively.

### Example 2

Samples of the same polypropylene spunbonded nonwoven web were corona discharge treated as described above. Prior to immersion in the acrylic acid monomer solution however, the nonwoven web was washed in methanol to remove any low molecular weight highly oxidized polymer which may have been present at the surface of the fibers. The methanol washed samples were then saturated with an aqueous acrylic acid solution as described in Example 1, nipped to remove excess solution and irradiated in the UV reactor as described above with respect to Example 1. Following irradiation in the UV reactor, the polyacrylic acid grafted samples were washed to remove any residual monomer and dried also as described in Example 1. Samples of the nonwoven web which had been washed with methanol after corona treatment were also found to be quite readily dyeable using both Saffranine O and Malachite green oxalate. In addition, ATR-FT-IR spectra obtained from the grafted coating were again consistent with a polyacrylic acid coating.

In order to test the permanence of the grafted polyacrylic acid coating, samples of the polyacrylic acid grafted nonwoven web described above were immersed in boiling water for 75 minutes. On removal from the boiling water, the samples were found to be uniformly coated with a thin layer of swollen polyacrylic acid gel. After drying, samples were again found to be dyeable with Saffranine O yielding a highly uniform deep red nonwoven fabric. ATR-FT-IR spectra collected from the grafted nonwoven web after treatment in boiling water revealed absorbance peaks at 1700 cm⁻¹, 1370 cm⁻¹, and 1160 cm⁻¹ consistent with spectra collected before the boiling water treatment. Thus, the infrared spectra and dye uptake results both indicate that the polyacrylic acid coating had not been removed.

In a second test of the permanence of the grafted polyacrylic acid coating, samples of the polyacrylic acid grafted nonwoven web were placed in 2M potassium hydroxide (KOH) at 100 degrees C. for 60 minutes. After the hot caustic wash, the grafted media was washed three times in deionized water to remove any excess of the caustic. The hot caustic washed sample was dried at 100° C. The dried sample was again found to be dyeable using Saffranine O dye yielding a reddish-orange fabric with good color uniformity. The color change from deep red to reddish-orange is believed to be due to a change in the nature of the functional groups in the grafted coating from carboxylic acids to carboxylate salts as a result of the harsh caustic wash. In addition, conversion to the carboxylate salt was accompanied by a change in the physical characteristics of the sheet material such that it was no longer as stiff and was more drapeable, similar to its condition prior to any treatment. ATR-FT-IR spectra revealed absorbance bands at 1540 cm⁻¹ and 1399 cm⁻¹ consistent with a carboxylate salt.

### Example 3

Samples of the same polypropylene spunbonded nonwoven web material were corona treated as in Example 1. The corona treated nonwoven web was then immersed in a solution of acrylic acid monomer to which a small amount of triallyl phosphate had been added. The mole ratio of acrylic acid monomer to triallyl phosphate was 160:1. The triallyl phosphate (TAP) was added as a trifunctional cross-linking agent for the grafted coating. After saturation and nipping to remove excess treatment solution, the nonwoven web material was placed in a tubular reactor, purged with nitrogen gas and irradiated with UV light for 10 minutes. Following the UV grafting, the nonwoven web sample was removed from the reactor and washed three times in deionized water, and dried. The resultant grafted fabric was again white in color and very stiff to the touch.

The TAP crosslinked grafted nonwoven web material was found to be dyeable with both Saffranine O and Malachite green oxalate dyes yielding deep red and green fabrics with good color uniformity, respectively. The permanence of the crosslinked grafted coating was tested in boiling water and hot caustic as described in Example 2. Following both treatments the polyacrylic acid grafted nonwoven web material remained dyeable with Saffranine O indicting that the coating was not removed by these treatments.

### Comparative Example 1A and 1B

An acrylate monomer and photoinitiator solution of the following composition was prepared: 69 weight percent deionized water, 30 weight percent acrylic acid monomer, 0.5 weight percent Irgacure® 2959 photoinitiator and 0.5 weight percent lauryl alcohol tetra-ethoxylate. The lauryl alcohol tetra-ethoxylate is a non-ionic surfactant that aids dispersal of the photoinitiator and also aids wetting of the sheet material by the monomer/photoinitiator solution. The photoinitiator Irgacure® 2959 is available from Ciba Specialty Chemicals (Tarrytown, N.Y.) and is recommended by the manufacturer for use in curing of water based coatings. Its chemical name is 4-(2-hydroxyethoxy) phenyl-(2-hydroxy-2-methylpropyl) ketone. It has a molar absorptivity (extinction coefficient) of 5.032×10⁴ L mol⁻¹ cm⁻¹ at 254 nanometers (the principle wavelength of the low pressure mercury lamps used in the photoreactor).

A sample of same polypropylene spunbonded nonwoven web was immersed in the solution described above, without first undergoing a corona treatment. The solution instantaneously wet and wicked into the nonwoven structure. The saturated nonwoven web was nipped between polyester film sheets to remove excess solution and placed in a tubular reactor which was capped and purged with nitrogen to remove oxygen. After the purging was completed the quartz tube reactor was placed in the photochemical reactor and irradiated for 10 minutes to produce Comparative Example 1A. Following irradiation, the sample was washed in deionized water three times and dried at 100 degrees C.

Samples of the Comparative Example 1A nonwoven fabric described above were immersed in aqueous solution of Saffranine O and Malachite green oxalate. The dye solutions did not spontaneously wet the surface modified nonwoven web, but required that the samples be forcibly immersed and held under the surface of each dye solution. After removal from the dye solution the modified nonwoven web was washed three times in deionized water. The resulting nonwoven fabric samples displayed very inhomogeneous coloration, appearing mottled or splotchy. The samples were characterized by deep red or green spots surrounded by areas that appeared either pink, light green, or white (i.e., apparently non-dyed). Examination of these materials using optical microscopy revealed that although the dye was retained in places in the fabric (the deeply dyed spots), these corresponded to gel-like particles that were trapped in the interstitial spaces between fibers, rather than being a coating on the surface of the fibers.

The above procedure was repeated using a longer (15 minute) UV irradiation time to produce Comparative Example 1B. However, after dyeing with Malachite green oxalate the fabric surface was again colored very inhomogeneously and appeared mottled rather than having a uniformly dyed appearance.

### Comparative Example 2

In a third attempt to surface modify the nonwoven web, trivinyl cyclohexane (TVC) was added to the monomer solution described above with respect to Comparative Examples 1A and 1B as a cross-linking agent. These nonwoven web samples again were not treated by corona discharge. After UV irradiation for 10 minutes and washing as described previously, the TVC cross-linked material was found to be dyeable using Saffranine O and Malachite green oxalate yielding fabrics with good color uniformity. However, examination of these fabrics after post-dye washing by visible light microscopy revealed a sample morphology wherein the hydrogel was not adhered to the fibers but rather was trapped between the fibers in the interstitial spaces.

The experimental results described above with respect to the Comparative Examples are consistent with the formation of a homopolymerized bulk hydrogel in the open spaces of the nonwoven, rather than formation of polymer chains initiated at the substrate surface and therefore grafted to the surface. In the case of the sample prepared with photoinitiator but without a crosslinking agent, the hydrogel formed was easily removed by washing with water indicating that it was weakly adhered but not bound or grafted to the polymer surface. The addition of a trifunctional crosslinking agent increased the durability of these coatings by making the coating more resistant to aggressive washing. However, microscopy clearly indicated that the fibers were encased in hydrogel which covered not only the fiber surfaces, but also filled the interstitial spaces between the fibers. That is, the polymerized monomer appeared to be an independent bulk homopolymer interspersed with the fibers of the substrate nonwoven web material.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A method for modifying a surface of a polymeric substrate, said method comprising:
a) providing a polymeric substrate;
b) exposing at least one surface of said polymeric substrate to energy to form surface radical forming groups on said at least one surface of said polymeric substrate;
c) treating said polymer substrate with a fluid comprising at least one type of monomer; and
d) subjecting said treated polymeric substrate to activation energy to cleave at least some of said radical forming groups and initiate graft polymerization of said monomer;
wherein the step of subjecting said treated polymeric substrate to activation energy is performed substantially in the absence of added photoinitiator.

2. The method of claim 1 wherein said polymeric substrate comprises a polymer selected from the group consisting of polyolefins and polyesters.

3. The method of claim 2, wherein said polymeric substrate comprises a polyolefin.

4. The method of claim 3, wherein said polyolefin comprises polypropylene.

5. The method of claim 1 wherein said fluid comprises one or more ethylenically unsaturated monomers.

6. The method of claim 5 wherein said ethylenically unsaturated monomer comprises an acrylic acid monomer or a methacrylic acid monomer.

7. The method of claim 1 wherein said polymeric substrate is a sheet material selected from the group consisting of nonwoven web materials, film materials, foam materials and laminates thereof.

8. The method of claim 7 wherein said polymeric substrate comprises a polymer selected from the group consisting of polyolefins and polyesters.

9. The method of claim 8 wherein said polymeric substrate is a nonwoven web material comprising polyolefin.

10. The method of claim 8 wherein said polymeric substrate is a film material comprising polyolefin.

11. The method of claim 1 wherein the step of exposing at least one surface of said polymeric substrate to energy to form surface radical forming groups is performed by exposing said polymeric substrate to corona discharge.

12. The method of claim 1 wherein said activation energy is ultraviolet radiation.

13. The method of claim 1 wherein the step of subjecting said treated polymeric substrate to activation energy is performed in a reduced oxygen condition.

14. The method of claim 1 wherein said fluid comprising monomer is an aqueous solution comprising monomer.

15. The method of claim 9 wherein said polymeric substrate is a nonwoven web material comprising polypropylene and wherein said monomer is an acrylic acid monomer.

16. The method of claim 1 wherein said fluid further comprises at least one crosslinking agent selected from the group consisting of triallyl phosphate, trivinyl cyclohexane, bis (2-methacryloxyethyl) phosphate, 1,4-butanediol diacrylate, 1,4-butanediol dimethacrylate, diethylene glycol diacrylate and diethylene glycol dimethacrylate.

17. A polymeric substrate comprising at least one modified surface, said surface modified in accordance with the method of claim 1.

18. A polymeric substrate comprising at least one modified surface, said surface modified in accordance with the method of claim 6.

19. A polymeric substrate comprising at least one modified surface, said surface modified in accordance with the method of claim 15.

20. The surface modified polymeric substrate of claim 17, wherein said substrate has been further treated with a strong Lewis base to form the conjugate base/conjugate acid salt.

21. The surface modified polymeric substrate of claim 17, wherein said substrate has been further treated with a weak Lewis base to form the conjugate base/conjugate acid salt.
